(19) United States
(12) Patent Application Publication
(10) Pub. No.: US 2002/0111189 A1
(43) Pub. Date: Aug. 15, 2002

(54) Cellular telephone with detachable radio

(76) Inventor: Ming-Hsun Chou, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/779,504

(22) Filed: Feb. 9, 2001

(51) Int. Cl. H04B 1/38

(52) U.S. Cl. 455/557; 455/550; 455/572

(57) ABSTRACT

A radio module detachably connects to a cellular telephone. The cellular telephone has a casing, a control circuit installed within the casing, a keypad electrically connected to the control circuit, and an external interface. The control circuit controls the operations of the cellular telephone. The keypad enables a user to direct the control circuit. The external interface has first contacts and an external connector with the first contacts electrically connected to the control circuit. The external connector detachably connects to a corresponding device. The radio module has a housing, a radio circuit installed within the housing, and a port. The port has a plurality of second contacts and a cellphone connector. The second contacts are electrically connected to the radio circuit. The cellphone connector detachably connects to the external connector of the cellular telephone. When the external connector of the cellular telephone is connected to the cellphone connector of the radio module, the first contacts are electrically connected to the second contacts, enabling the control circuit to send control signals to the radio circuit to control operations of the radio circuit. The user uses the keypad to direct the control circuit to generate the control signals, and the radio module enables the user to listen to broadcast radio programs according to the control signals.

### BACKGROUND OF THE INVENTION

1. Field of the Invention

The present invention relates to a cellular telephone. More specifically, the present invention discloses a cellular telephone with a detachable radio module.

2. Description of the Prior Art

Cellular telephones have become increasingly ubiquitous over the years, with a steady drop in unit prices that have made them affordable for a large cross-section of society. The options available on newer models of cellular telephones have also grown, enabling users to access such features as sending personalized text and graphics to the cellular telephones of another user, browsing the Internet and even sending and receiving electronic mail. Despite the availability of such a wide variety of options, many users still carry around a separate portable radio to listen to music and news, as cellular telephones currently do not support such a basic need. Users must consequently carry around two portable devices, which, though both are small in size, is still inconvenient.

### SUMMARY OF THE INVENTION

It is therefore a primary objective of this invention to provide a radio module that detachably connects to a cellular telephone to enable a user to listen to broadcast radio programs.

The present invention, briefly summarized, discloses a radio module that detachably connects to a cellular telephone. The cellular telephone has a casing, a control circuit installed within the casing, a keypad electrically connected to the control circuit, and an external interface. The control circuit controls operations of the cellular telephone. The keypad enables a user to direct the control circuit. The external interface has first contacts and an external connector. The first contacts are electrically connected to the control circuit. The external connector detachably connects to a corresponding device. The radio module has a housing, a radio circuit installed within the housing, and a port. The port has a plurality of second contacts and a cellphone connector. The second contacts are electrically connected to the radio circuit. The cellphone connector detachably connects to the external connector of the cellular telephone. When the external connector of the cellular telephone is connected to the cellphone connector of the radio module, the first contacts are electrically connected to the second contacts, enabling the control circuit to send control signals to the radio circuit to control operations of the radio circuit. The user uses the keypad to direct the control circuit to generate the control signals, and the radio module enables the user to listen to broadcast radio programs according to the control signals.

It is an advantage of the present invention that the radio module is relatively small in size, as it uses the input and output interface of the cellular telephone to control its operations, and thus requires no external buttons or knobs. Additionally, the radio module can obtain its power from the battery of the cellular telephone, further reducing its size requirements. Finally, the radio module can be easily attached or detached from the cellular telephone, increasing the versatility of the cellular telephone.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a perspective view of a present invention cellular telephone and radio module.

FIG. 2 is a functional block diagram of the cellular telephone and the radio module shown in FIG. 1.

FIG. 3 illustrates a sample user interface radio module of the present invention.

FIG. 4 is a perspective view of another embodiment radio module and a battery source.

FIG. 5 is a functional block diagram of the radio module and battery source shown in FIG. 4.

### DETAILED DESCRIPTION OF THE PREFERRED EMBODIMENT

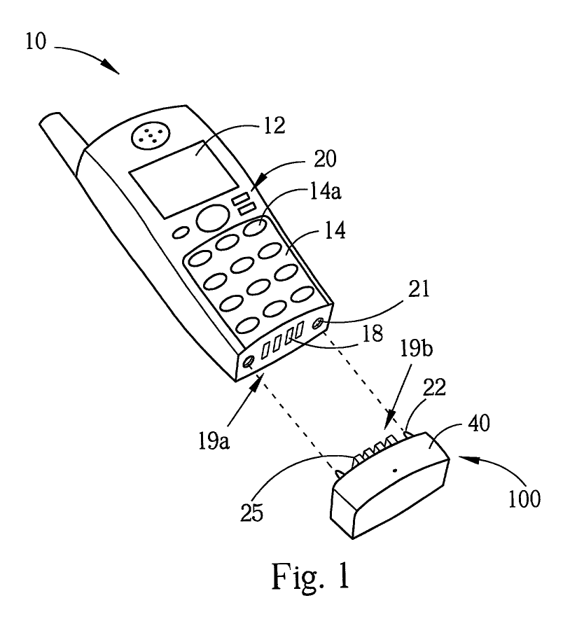

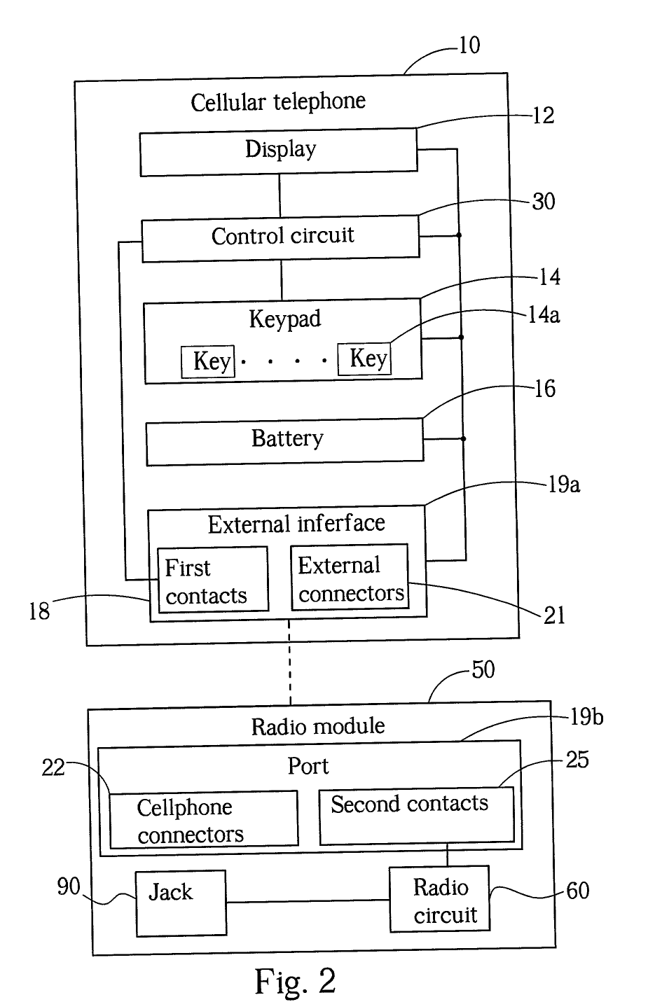

Please refer to FIG. 1 and FIG. 2. FIG. 1 is a perspective view of a present invention cellular telephone 10 and radio module 50. FIG. 2 is a functional block diagram of the cellular telephone 10 and the radio module 50 shown in FIG. 1. The cellular telephone 10 comprises a casing 20, a control circuit 30 installed within the casing 20 to control operations of the cellular telephone 10, a display 12, a keypad 14, and a battery 16. The display 12 and the keypad 14 are located on the surface of the casing 20 of the cellular telephone 10, and both are electrically connected to the control circuit 30. The display 12 presents visual information to a user, and the keypad 14 enables the user to direct the control circuit 30 by pressing keys 14a on the keypad 14. The battery 16 is detachably connected to the cellular telephone 10 and provides electrical power to all of the components of the cellular telephone 10. The external interface 19a is located on one lateral surface of the casing 20 of the cellular telephone 11, and comprises first contacts 18 and external connectors 21. The first contacts 18 are electrically connected to the control circuit 30. The external connectors 21 detachably connect to corresponding connectors 22 of the radio module 50. The external connectors 21 are thus used to detachably connect the radio module 50 to the cellular telephone 10. The first contacts 18 are used to provide power and signal information from the cellular telephone 10 to the radio module 50.

The radio module 50 comprises a housing 40, a radio circuit 60 installed within the housing 40 to control operations of the radio module 50, a port 19b, and an audio output jack 90. The port 19b is positioned on one side of the radio module 50 and comprises second contacts 25 and cellphone connectors 22. The second contacts 25 are electrically connected to the radio circuit 60. The cellphone connectors 22 are adapted to detachably connect to the external connectors 21 of the cellular telephone 10. When the user desires to utilize the radio feature of the cellular telephone 10, the user attaches the radio module 50 to the cellular telephone 10 by mating the cellphone connectors 22 of the radio module 50 to the external connectors 21 of the cellular telephone 10. In doing so, the second contacts 25 of the radio module 50 establish electrical contact with the first contacts 18 on the cellular telephone 10. The result is an electrical connection made between the control circuit 30 of the cellular telephone 10 and the radio circuit 60 of the radio module 50. The electrical connection enables the control circuit 30 of the cellular telephone 10 to send control signals to the radio circuit 60 to control operations of the radio circuit 60. Furthermore, the radio module 50 can draw power from the battery 16 of the cellular telephone 10. By using the audio output jack 90, the radio module 50 enables the user to listen to broadcast radio programs. The user can plug conventional speakers or headphones (not shown) into the audio output jack 90 to hear the radio programs. By using the keypad 14, the user can direct the control circuit 30 to generate control signals to control the operations of the radio module 50. Additionally, the control circuit 30 can control the display 12 to provide the user with visual information about the radio module 50.

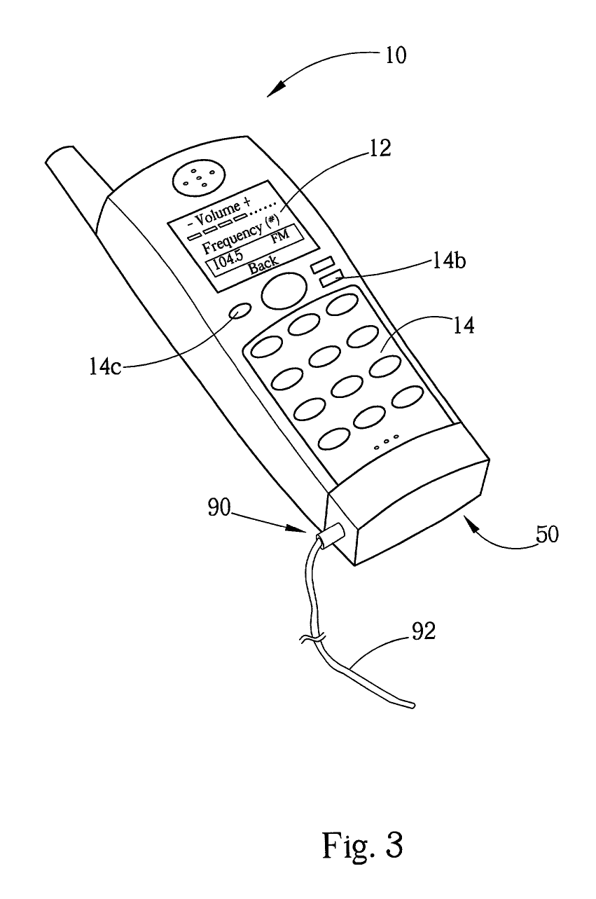

Please refer to FIG. 3 in conjunction with FIGS. 1 and 2. FIG. 3 is a diagram illustrating a sample user interface for the radio module 50. Similar to the functions featured on a standard radio, the radio module 50 can adjust such factors as output volume and tuning frequency. However, the radio module 50 adjusts these functions according to control signals received from the cellular telephone 10. These control signals are generated by the control circuit 30 according to user input from the keypad 14. For instance, the user can press keys 14b or 14c on the keypad 14 to either increase or decrease the output volume, respectively, while pressing the numeric keys on the keypad 14 enables the user to directly enter the tuning frequency. Alternatively, by pressing the pound (#) or star (*) keys on the keypad 14, the user may indicate a forward scanning to change the frequency, or a backwards scanning. Many other options and combinations are possible for the user interface, such as the setting of user-definable stations, etc. All adjustment information about the radio module 50 is viewed on the display 12 of the cellular telephone 10. The user is provided with audio output via an audio output jack 90 located on a side surface of the radio module 50. The audio output jack 90 is electrically connected to the radio circuit 60 and is adapted to electrically connect to an audio device. For example, the audio output jack can be a headphone jack to electrically connect to a headphone 92 for personal listening.

The radio module 50 also has the added feature of switching to a background music mode or a disabled mode. For instance, the user can use the keypad 14 to select a background music mode indicated on the display 12. Once selected, the radio module 50 provides background music during a calling session. That is, while using the cellular telephone 10 to talk to another user, the cellular telephone 10 will mix together both the voice information from the user with the radio program information. In this manner, the user at the other end of the line will be able to hear both the radio program and the user to whom he or she is talking. The radio module 50 uses the second contacts 25 to deliver the radio program information to the cellular telephone 10. Note that it is the job of the cellular telephone 10 to perform the audio mixing, and as such it may also be necessary to provide a mixer feature on the cellular telephone 10 to allow the user to select the relative mixing weights of voice and radio signals. Conversely, the user may decide to select a disabled mode offered on the display 12. When this disabled mode is selected, the control circuit 30 causes the radio module 50 to be disabled when the cellular telephone 10 receives an incoming call. This can prevent the user from being distracted from unwanted noise from the radio module 50 while the user is talking on the cellular telephone 10.

The radio module 50 not only enables the user to listen to broadcast radio programs, it may also allow the user to listen to the audio portion of a television signal. Firstly, the user selects the television setting rather than the radio setting shown on the display 12 via the keys 14a of the keypad 14. Once the television setting is selected, the radio module 50 demodulates the audio portion of the television signal so that the user is able to hear the television program via the headphones 92.

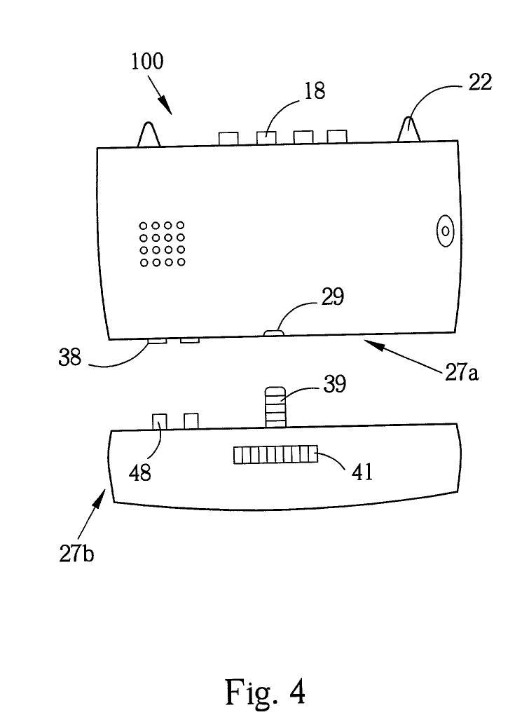

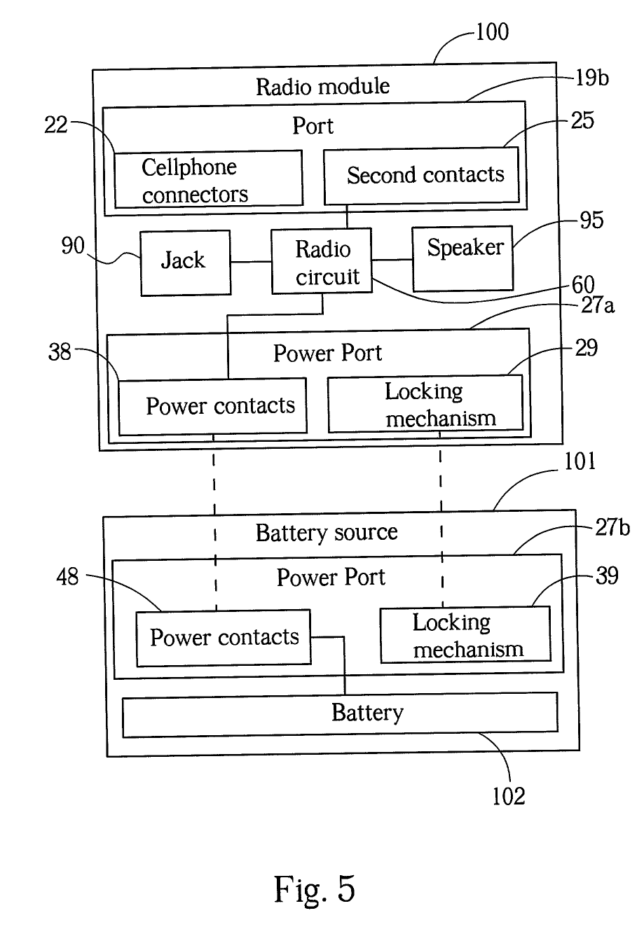

Please refer to FIG. 4 and FIG. 5. FIG. 4 is a perspective view of another embodiment of a present invention radio module 100 and a battery source 101. FIG. 5 is a functional block diagram of the radio module 100 and a battery source 101 shown in FIG. 4. The same item numbers are kept for those items on the radio module 100 that serve the same function as on the previous embodiment radio module 50. The radio module 100 has all of the features of the radio module 50. Additionally, the radio module 100 comprises a speaker 95 and a power port 27a. The power port 27a is designed to detachably connect to a corresponding power port 27b on a battery source 101. In this manner, the radio module 100 can obtain electrical power from the battery source 101, as opposed to the radio module 50 (as shown in FIG. 1 and FIG. 2), which obtains its electrical power via the battery of the cellular phone 10. The power port 27a comprises power contacts 38 and a locking mechanism 29 that are located on a side surface of the radio module 100 opposite the port 19b. The power contacts 38 electrically connect to the radio circuit 60. The locking mechanism 29 could be, for example, a hole adjacent to the power contacts 38. On a side surface of the battery source 101 are power contacts 48 designed to mate with the power contacts 38 of the radio module 100, and a locking mechanism 39 designed to mate with the locking mechanism 29 of the radio module 100. The locking mechanism 30 of the battery source 101 could be, for example, a screw rotatably connected to a fastener 41. The battery source 101 holds at least one battery 102 that is electrically connected to the power contacts 48 of the battery source 101. When the user desires to utilize the battery source 101 for the radio module 100, the user inserts the screw 39 into the hole 29 and turns the fastener 41 to lock the battery source 101 into place. Electrical contact is thereby established between the power contacts 38 of the radio module 100 and the power contacts 48 of the battery source 101 to provide power to the radio module 100. The speaker 95, which is electrically connected to the radio circuit 60, can also be used as an audio output device. Thus, when the audio output jack 90 is not connected to an audio device such as a headphone, the user is provided with audio output via the speaker 95.

In contrast to the prior art, the present invention provides a cellular telephone with an added radio function. Broadcast radio programs can be transmitted to the user via a radio module that is detachably connected to the cellular telephone. The radio module is small in size since the keypad of the cellular telephone is used to control the functions of the radio module, and the radio module can draw power from the cellular telephone. As well, the radio feature of the cellular telephone does not interrupt the innate function of the cellular telephone since incoming calls can still be received by the cellular telephone. The user has the choice of having the audio output become background music during a calling session or have the radio module disabled upon receiving an incoming call. Thus, a separate radio device is no longer required to be carried around but is provided as an added, portable feature detachably connected to a cellular telephone.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A radio module adapted to be detachably connected to a cellular telephone, the cellular telephone comprising:
a casing;
a control circuit installed within the casing, the control circuit controlling operations of the cellular telephone;
a keypad electrically connected to the control circuit to enable a user to direct the control circuit; and
an external interface comprising first contacts and an external connector, the first contacts electrically connected to the control circuit, the external connector adapted to detachably connect to a corresponding device;
the radio module comprising:
a housing;
a radio circuit installed within the housing; and
a port comprising a plurality of second contacts and a cellphone connector, the second contacts electrically connected to the radio circuit, the cellphone connector adapted to detachably connect to the external connector of the cellular telephone;
wherein when the external connector of the cellular telephone is connected to the cellphone connector of the radio module, the first contacts are electrically connected to the second contacts enabling the control circuit to send control signals to the radio circuit to control operations of the radio circuit, the user uses the keypad to direct the control circuit to generate the control signals, and the radio module enables the user to listen to broadcast radio programs according to the control signals.

2. The radio module of claim 1 further comprising an audio output jack adapted to electrically connect to an audio device for providing audio output to the user, the audio output jack electrically connected to the radio circuit.

3. The radio module of claim 2 wherein the audio output jack is a headphone jack adapted to electrically connect to a headphone.

4. The radio module of claim 1 further comprising a speaker for providing audio output to the user, the speaker electrically connected to the radio circuit.

5. The radio module of claim 1 wherein the radio module obtains electrical power from a battery of the cellular telephone.

6. The radio module of claim 1 further comprising a battery for providing electrical power to the radio module.

7. The radio module of claim 1 wherein the radio module adjusts an output volume according to the control signals received from the cellular telephone.

8. The radio module of claim 1 wherein the radio module adjusts a tuning frequency for the radio circuit according to the control signals received from the cellular telephone.

9. The radio module of claim 1 wherein the radio module switches between a background music mode and a disabled mode according to the control signals received from the cellular telephone.

10. The radio module of claim 1 wherein the radio module switches between a radio and a television setting according to the control signals received from the cellular telephone.

11. The radio module of claim 1 wherein the cellular telephone further comprises a display for presenting visual information to the user, the display electrically connected to the control circuit, and the control circuit controls the display to present information about the radio module.

12. The radio module of claim 1 wherein during a calling session with the cellular telephone, the radio module provides background music for the calling session.

13. The radio module of claim 1 wherein the control circuit causes the radio module to be disabled when the cellular telephone receives an incoming call.

14. The radio module of claim 1 wherein the radio module demodulates an audio portion of a television signal to enable the user to listen to the audio portion of the television signal.
